(19) United States
(12) Patent Application Publication
(10) Pub. No.: US 2009/0172907 A1
(43) Pub. Date: Jul. 9, 2009

(54) WIPER BLADE

(75) Inventors: Bruno Egner-Walter, Heilbronn (DE); Michael Schauble, Vaihingen/Enz (DE)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, La Verriere (FR)

(21) Appl. No.: 12/281,587

(22) PCT Filed: Mar. 21, 2007
(86) PCT No.: PCT/EP2007/002486

§ 371 Date: Sep. 3, 2008

(30) Foreign Application Priority Data
Mar. 25, 2006 (DE) 10 2006 013 900.3

(51) Int. Cl. B60S 1/32

(52) U.S. Cl. 15/250.01

(57) ABSTRACT

A flat wiper blade, for cleaning windscreens on vehicles, including a spray duct with spray openings on at least one longitudinal side of a wiper blade for applying a washing fluid or cleaning fluid to a windscreen, a port for connecting the at least one spray duct to at least one outer line for feeding the washing fluid, and an adapter for connecting the flat wiper blade to a wiper arm of a wiper device, where the port is provided between the adapter and a wiper blade end.

The invention relates to a wiper blade, in particular a flat wiper blade, for a wiping device for cleaning windscreens on vehicles, for example for cleaning vehicle front windscreens according to the generic term of claim 1.

In order to improve cleaning of vehicle windscreens it is well known (DE 100 00372 A1) to make provision in wiper blades for at least one spray duct extending in the direction of a longitudinal axis of a wiper blade which (spray duct) is equipped with a large number of spray openings. By means of the latter, on operating the windscreen wiper module, a washing fluid or cleaning fluid (in the simplest case water with cleaning and/or antifreeze additives) can be applied to the windscreen to be cleaned and to be more precise, in the immediate vicinity of the wiping lip formed by the wiping rubber and the rubbery-elastic wiping strip for example.

For feeding the washing fluid and cleaning fluid, the spray duct is connected in the well known case to an outer hose line at one end of the flat wiper blade. The disadvantage in this case is that the hose line, starting from the wiper arm of the wiper device extends over a relatively long exposed length, which is not only determined by the distance of the respective wiper blade end from the wiper arm with the wiper blade lying against the vehicle windscreen, but also by the curvature that the wiper blade presents with the wiper blade folded away from the vehicle windscreen. This exposed length of hose is at least visually objectionable, but can also be very rapidly damaged in carwashes for example.

It has already been proposed (DE 10 2004 056 835.9) to design the adapter with which the wiper blade is connected to the wiper arm as a connecting and distributing element by means of which the at least one outer line for feeding the washing fluid or cleaning fluid is connected to the spray duct formed in the wiper blade. This however implies a specific constructive embodiment of the adapter.

The purpose of the invention is to demonstrate a wiper blade that avoids the disadvantage of the well known wiper blades initially mentioned and allows a simplified connection of the at least one spray duct to the corresponding outer connection line for feeding the washing fluid or cleaning fluid. In order to solve this problem, a wiper blade according to patent claim 1 is designed.

A considerable advantage of the design according to the invention lies in the fact that long, exposed lines or hose lengths for feeding the washing fluid or cleaning fluid are avoided and equally feeding of the cleaning fluid and washing fluid by means of the adapter designed as a connecting and distributing element. In a preferred embodiment of the invention, the at least one port is positioned on the side of the adapter facing the wiper shaft.

Further developments of the invention are the subject of the subclaims. The invention will be explained in further detail below based on the figures in examples of embodiment.

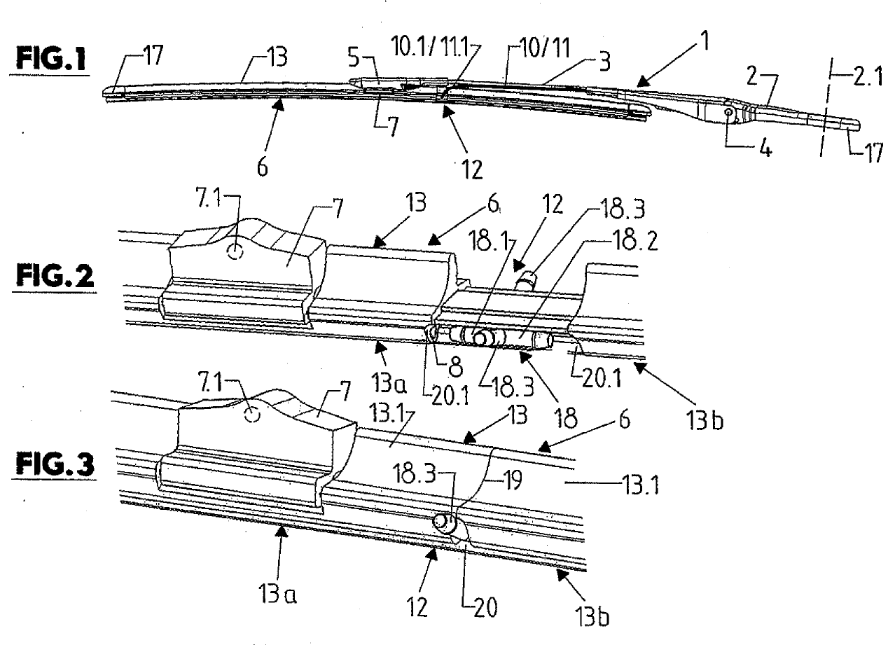

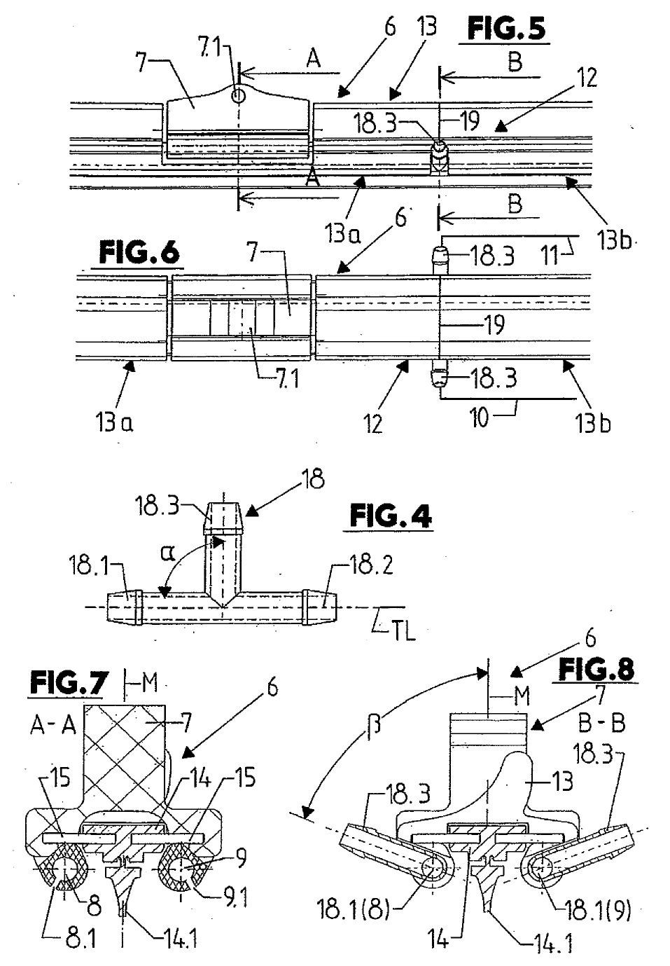

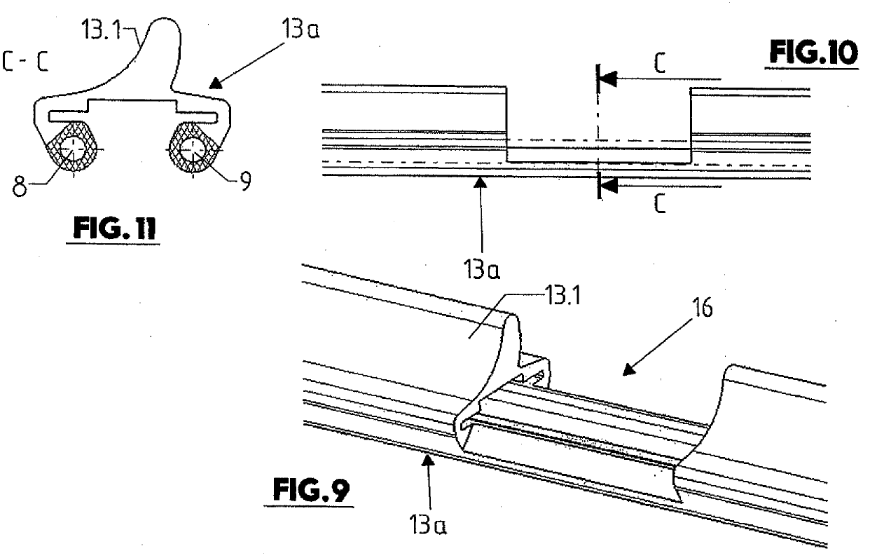

FIG. 1 shows a simplified representation and a side view of a wiper arm together with a wiper blade according to the invention;

FIGS. 2 and 3 show in perspective partial representations the wiper blade in the area of the adapter and the adjacent port for the spraying fluid;

FIG. 4 shows in an individual representation a T-piece for use with the port in FIGS. 2 and 3;

FIGS. 5 and 6 show the wiper blade in FIGS. 2 and 3 in a partial representation and a side view in addition to a top view, again in the area of the adapter and the port for the spraying fluid;

FIGS. 7 and 8 show sections according to lines A-A and B-B;

FIG. 9-11 show the design of the wiper blade in the area of a recess provided for installation of the adapter in a perspective representation, in a side view and in a section according to the line C-C;

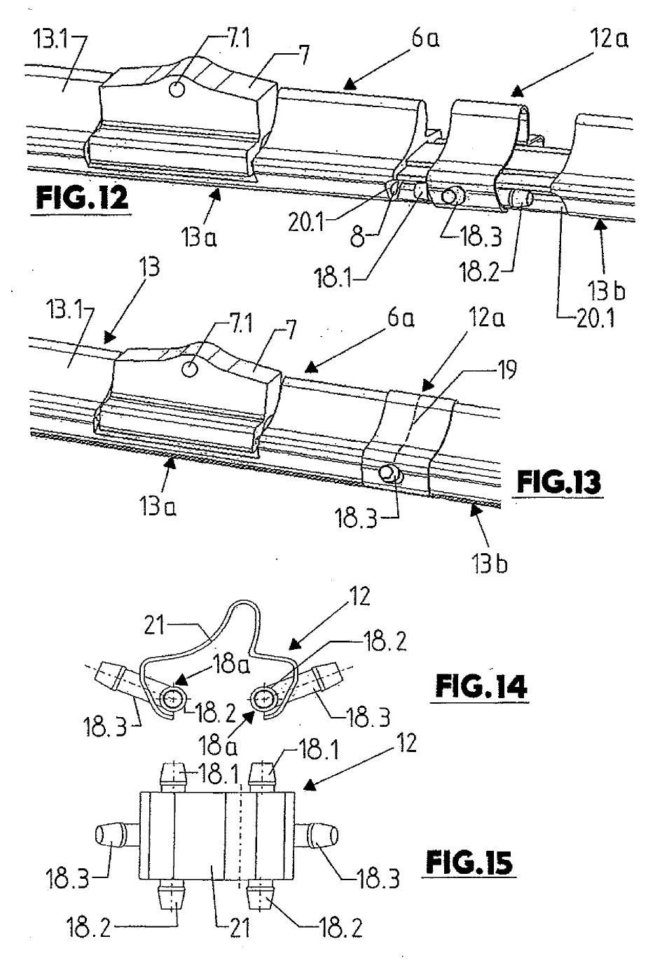

FIGS. 12 and 13 show a further embodiment of the wiper blade according to the invention in representations similar to those in FIGS. 2 and 3;

FIGS. 14 and 15 show, in a front view and a top view, a port with an integrated shield for use with the wiper blade in FIGS. 12 and 13;

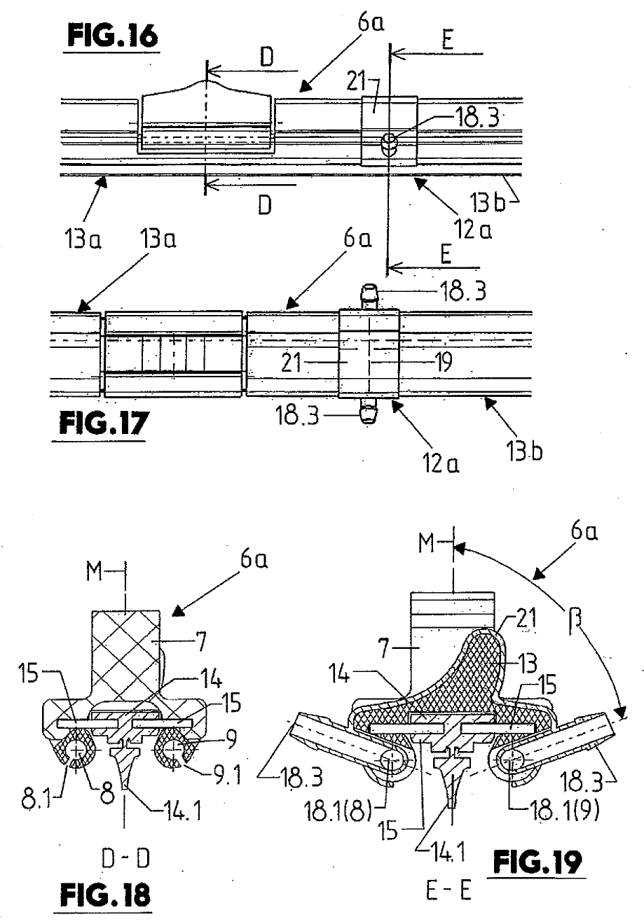

FIGS. 16 and 17 show the wiper blade in FIGS. 12 and 3 in a partial representation and in a side view in addition to a top view;

FIGS. 18 and 19 show cross-sections along lines D-D and E-E;

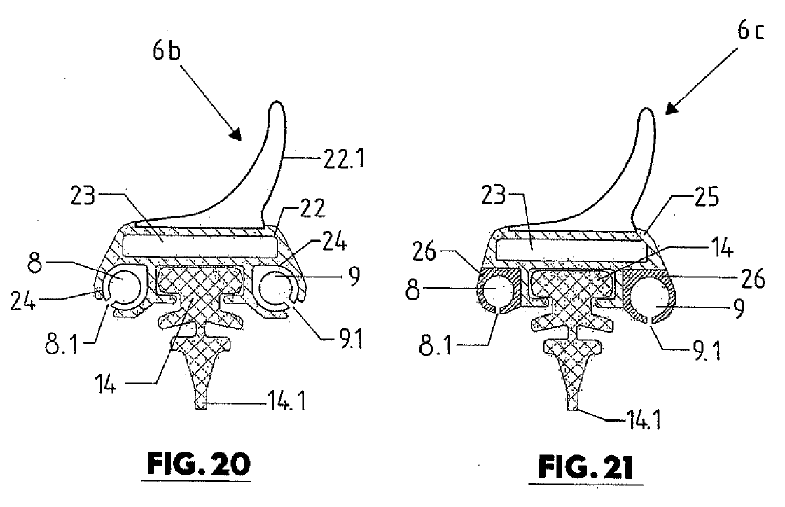

FIGS. 20 and 21 show sections through wiper blades corresponding to further embodiments of the invention.

FIG. 1 shows a wiper arm of a windscreen wiper arrangement for vehicle front windscreens of conventional construction, i.e. consisting of a bearing element 2, with which one end of the wiper arm is attachable to the wiper shaft implied by the line 2.1 of a windscreen wiper gear which is not illustrated well known to the specialist and consisting of the wiper arm element 3 (wiper arm rod), one end of which has an articulated connection to the bearing element 4 by means of an joint 4 and the other end of which is provided with a connecting piece 5 (slide) to which the wiper blade 6 is detachably connected.

For attachment to the connecting piece 5, the wiper blade 6 presents an adapter 7 manufactured as a plastic moulded component, which is overlapped by the connecting piece 5 for example in the manner of a slide. The connecting piece 5 is joined to the adapter 7 in the simplest case by a connecting bolt provided on the connecting piece 5 and engaging in an opening 7.1 in the adapter 7.

The wiper blade 6 is equipped on both of its longitudinal sides respectively with a spray duct 8 and 9 for a spraying or cleaning fluid (water with cleaning additives and/or antifreeze agents if appropriate) to be applied to the vehicle windscreen. Each spray duct 8 and 9 forms a multitude of outlet or spray openings 8.1 and 9.1, which are distributed over each longitudinal side of the wiper blade 6. Two outer hose lines 10 and 11 serve to feed the spraying or cleaning fluid to the spray ducts 8 and 9, which (hose lines) are fed along the wiper arm 1, are connected at one end by means of connecting pieces of a port 12 to the respective spray duct 8 and 9 and at the other end to a source provided in the vehicle, which (source) controls the cleaning fluid and supplies the latter under pressure. The port 12 is therefore designed as a double port for two outer hose lines 10 and 11.

As FIGS. 2-11 in particular also show, the wiper blade 6 is designed as a flat wiper blade. It essentially consists of a strip-like wiper blade body 13, manufactured from material suitable for such wiper blade bodies or elements, for example from a slightly elastic plastic and which is shaped as a spoiler on its upper side facing away from the vehicle screen in 13.1. The two distributing or spray ducts 8 and 9 and the corresponding jet openings 8.1 and 9.1 are also provided in this wiper blade body 13.

The wiper blade 6 furthermore consists of the wiping rubber 14 manufactured from a rubbery-elastic material, for example rubber or an elastomeric plastic, which forms the wiping lip 14.1 lying against the vehicle windscreen, in addition to the two spring rails 15 respectively provided on a longitudinal side of the wiping rubber 14. Part of the width of these spring rails are received in the wiping rubber and engage with a section of their width projecting over the respective longitudinal side of the wiping rubber in a groove of the wiper blade body 13 overlapping the spring rails 15 and the wiping rubber. The wiper blade body 13 is suitably recessed in 16 for the adapter 7 and indeed in such a way that in the area of this recess, the top profile section of the wiper blade body 13 forming the spoiler 13.1 is interrupted and the two spring rails are exposed at their section laterally projecting from the wiping rubber 14, so that the adapter 7 overlaps in the manner of a slide the wiping rubber 14 on its upper side facing away from the wiping lip 14.1 and the spring rails 15 exposed in the area of the recess 16, which are received for retaining the adapter 7 in groove-like recesses of the adapter. As FIGS. 9-11 in particular show, the recess 16 is designed such that it does not interrupt the spray ducts 8 and 9. M designates in the figures a central plane which includes the longitudinal axis of the wiper blade 6 and in relation to which at least the wiping rubber 14, including the wiping lip 14.1 is designed symmetrically and which, with the wiper arm 1 and wiper blade 6 installed, is oriented vertically or approximately vertically to the vehicle windscreen.

The wiper blade body 13, wiping rubber 14 and the two spring rails 15 respectively extend over the entire or almost the entire length of the wiper blade 6. At both ends, the wiper blade 6 is equipped respectively with a cap 17 manufactured as a plastic moulded component, which holds together the wiper blade body 13, the wiping rubber 14 and the spring rails 15 and also hermetically seals the two spray ducts 8 and 9 as an end piece.

A particularity of the wiper blade 6 lies in the fact that the port 12 connecting the spray ducts 8 and 9 to the lines 10 and 11 is arranged laterally from the adapter 7, i.e. between the latter and one end of the wiper blade 6 and to be more precise, in the embodiment presented, between the adapter 7 and the end of the wiper blade located closer to the wiper shaft 2.1. The distance between the port 12 and the adapter 7 is considerably less than the distance between the port 12 and the end of the wiper blade 6 on the wiper shaft side.

A particular advantage of this development lies in the fact that with short exposed, i.e. not fed along the wiper arm 1, partial lengths 10.1 and 11.1 of the hose lines 10 and 11 and with a simple design of the adapter 7, the spray and cleaning fluid does not need to be supplied over the area of the connecting piece 5 and the adapter 7.

In the wiper blade 6, the port 12 presents as connecting pieces two T-pieces 18 with three pipe unions 18.1, 18.2 and 18.3, of which the pipe unions 18.1 and 18.2 arranged in the same axis as one another in addition to in the same axis as a T-piece longitudinal axis TL form a continuous tube piece or connection piece open at both ends and the pipe union 18.3 forms an angle α with its longitudinal axis with the T-piece longitudinal axis. The angle α amounts to 90° in the embodiment presented, but may also differ from this value, i.e. be bigger or smaller than 90°.

At the position where the port 12 and its T-pieces 18 are provided the wiper blade body 13 is divided, so as to form two wiper arm sections 13a and 13b. On the separating plane 19, which is oriented vertically to the longitudinal plane of the wiper blade 6, a T-piece 18 is provided respectively on both longitudinal sides of the wiper blade 6 and to be more precise, such that the two pipe unions 18.1 and 18.2 respectively engage in the partial lengths of the spray duct 8 and 9 adjacent to the separating plane 19 and the pipe union 18.3 projects laterally over the relevant longitudinal side of the wiper blade and to be more precise such that the pipe unions 18.3 of the two T-pieces respectively form an angle β with the central plane M, which (angle) opens to the upper side of the wiper blade 6 facing away from the wiping lip 14.1 and is smaller than 90°.

In order to ensure that the two sections 13a and 13b of the wiper blade body 13 are closely adjacent to one another in the area of the separating plane 19 with the wiper blade 6 in its completely installed condition, these sections are provided at this position with a recess 20.1 respectively, which creates a free space 20 for the pipe union 18.3, out of which the end of this pipe union to be connected to the respective hose line 10 and 11 projects.

The adapter 7 is installed in the area of the recess 16 by pushing the section 13a equipped with this adapter on to the spring rails 15 preinstalled on the wiping rubber 14.

The port 12 is installed such that the sections 13a and 13b initially still at an interval from one another, but already installed on the spring rails 15 and the wiping rubber 14, with T-pieces 18 arranged between these sections, are pushed together, so that during this pushing together, the pipe unions 18.1 and 18.2 are introduced into the spray ducts 8 and 9 and the pipe unions 18.3 project over a longitudinal side of the wiper blade respectively.

Installation of the wiper blade 6 is completed by applying the caps 17 to both wiper blade ends.

FIGS. 12-19 show as a further embodiment a wiper blade 6a which only differs from the wiper blade 6 in that instead of the port 12 with two separated T-pieces 18, a port 12a is provided on which the T-pieces 18a corresponding to the T-pieces are provided on a shield 21 or manufactured in one piece with the latter as a plastic moulded component. The thin-walled shield possesses a contour on the outer surface and inner surface which is adapted to the contour of the outer cross-section of the wiper blade body 13 such that the shield 21 can be appropriately pushed on to the ends of the two sections 13a and 13b and indeed in such a way that with the wiper blade 6 installed, it completely covers the separating plane and the gap formed by the latter.

Installation of the port 12a is also performed in this embodiment according to FIGS. 12 and 13 such that the sections 13a and 13b initially still at an interval from one another, but already installed on the spring rails 15 and the wiping rubber 14 are connected to the port 12a by pushing together. During this pushing together, the pipe unions 18.1 and 18.2 are introduced into the spray ducts 8 and 9. After pushing together of the sections 13a and 13b, the latter closely adjoin each other on the separating plane 19. The separating plane 19 is covered by the shield 21.

In this embodiment also, the pipe unions 18.3 are oriented such that they again form the angle β with the central plane M. Furthermore, the two sections 13a and 13b for creation of the free space 20 for the pipe union 18.3 are equipped with the recesses 20.1.

FIG. 20 shows as a further embodiment a wiper blade 6b in which instead of the wiper blade body 13, a wiper blade body 22 is used, which is manufactured from a suitable material, plastic for example and positively surrounds the wiping rubber on its upper side facing away from the wiping lip 14.1. The wiper blade body 22 surrounds a single spring rail 23 located above the wiping rubber in the wiper blade body 22. On the upper side facing away from the wiping lip 14.1, a spoiler profile 22.1 is fixed to the wiper blade body 22. A tube profile 24 forming the respective spray duct 8 and 9 with the outlet openings 8.1 and 9.1 is fixed by clip-fitting on the two longitudinal sides of the wiper blade body 22. The connection with the outer hose lines 10 and 11 is also realised in the case of the wiper blade 6b for example in the form in which it has been described for the wiper blade 6 or 6a.

FIG. 21 shows a cross-section through a wiper blade 6c, which essentially differs from the wiper blade 6b in that on each longitudinal side of the wiper blade body 25 corresponding to the wiper blade body 22, instead of the tube profiles 24, tube profiles 26 are provided that respectively form a spray duct 8 and 9 with the corresponding spray openings or outlet openings 8.1 and 9.1 and which are retained on the wiper blade element 25 by gluing or welding or in another suitable manner.

The invention has been described above based on examples of embodiment. It is understood that many modifications and variations are possible without departing from the concept on which the invention is based. It is therefore possible for example to design the respective wiper blade element 13 and 22 or 25 with the spray ducts 8 and 9 extending continuously over the entire length of the wiper blade and establish the respective connection with the spray ducts 8 and 9 by the wiper blade body after installation being equipped for instance with an orifice opening into the respective spray duct 8 and 9 by piercing, punching out, etc. for example and a pipe union allowing the connection to the outer hose line 10 and 11 being subsequently inserted and anchored in the orifice, e.g. by gluing, welding, catch-fitting, etc.

### LIST OF REFERENCES

1 wiper arm

2 bearing element

2.1 wiper shaft axis

3 wiper arm element or wiper arm rod

4 joint.

5 connecting piece or slide

6, 6a, 6b, 6c wiper blade

7 adapter

7.1 adapter opening

8, 9 distributing or spray duct

8.1, 9.1 spray opening

10, 11 hose line

10.1, 11.1 exposed partial length of the hose

line 10 and 11

12, 12a port

13 wiper blade body

13a, 13b section of the wiper blade body

13.1 spoiler

14 wiping rubber

14.1 wiping lip

15 spring rail

16 recess for adapter 7

17 cap

18, 18a T-piece

18.1, 18.2, 18.3 pipe unions

19 separating plane

20 free space

20.1 recess

21 shield

22 wiper blade body

22.1 spoiler

23 spring rail

24 tube profile

25 wiper blade body

26 tube profile

M central plane

TL T-piece longitudinal axis

α, β angle

1. A flat wiper blade, for cleaning windscreens on vehicles, comprising:
at least one spray duct with spray openings on at least one longitudinal side of a wiper blade for applying a washing fluid to a windscreen, wherein the washing fluid is used to clean the windscreen,
at least one port for connecting the at least one spray duct to at least one outer line for feeding the washing fluid; and
at least one adapter for connecting the flat wiper blade to a wiper arm of a wiper device,
wherein the at least one port is provided between the adapter and a wiper blade end.

2. The wiper blade according to claim 1, wherein the at least one port is provided between the adapter and the wiper blade end adjacent to a wiper shaft.

3. The wiper blade according to claim 1, wherein the at least one port is located a greater distance away from the wiper blade end than from the adapter.

4. The wiper blade according to claim 1, wherein the at least one spray duct forms at least two partial lengths respectively extending from the port in the longitudinal direction of the wiper blade.

5. The wiper blade according to claim 4, wherein the partial lengths of the at least one spray duct are connected to each other by one of the at least one port and a connecting element forming the at least one port.

6. The wiper blade according to claim 5, wherein the connecting piece for formation of a first and a second pipe union configured to be connected with one partial length respectively of the at least one spray duct is designed in the manner of a tube section, and wherein the connecting piece presents a third laterally projecting pipe union configured to connect to the outer line.

7. The wiper blade according to claim 6, wherein the connecting piece is a T-piece.

8. The wiper blade according to claim 4, wherein the at least one spray duct is formed in a strip-like wiper blade body, wherein the wiper blade body consists of two sections which join together at the at least one port.

9. Te wiper blade according to claim 8, wherein the at least one connecting element is arranged at least partially between the wiper blade sections adjoining one another and in recesses formed on the sides adjacent to each other of the wiper blade sections adjoining one another.

10. The wiper blade according to claim 8, further comprising:
a shield covering the connection area between the wiper blade body sections.

11. The wiper blade according to claim 10, wherein the shield is a part of the at least one port and is manufactured in one piece with the connecting element of the at least one port.

12. The wiper blade according to claim 8, wherein a recess for the adapter is provided in the wiper blade body such that the at least one spray duct is uninterrupted in the area of the recess.

13. The wiper blade according to claim 8, wherein the at least one spray duct is moulded in the wiper blade body.

14. The wiper blade according to claim 1, wherein the one spray duct is formed of a tube section, which is fixed to the at least one longitudinal side of the wiper blade by one of gluing, welding, and catch-fitting.

15. The wiper blade according to claim 1, wherein an end cap is applied on the ends of the wiper blade, respectively, wherein the end cap is configured to close the at least one spray duct.

16. The wiper blade according to claim 1 wherein, on both longitudinal sides of the wiper blade, at least one spray duct is provided, wherein the at least one spray duct is connected to an outer line by means of the port and presents the spray openings.

17. The wiper blade according to claim 16, wherein the at least one spray duct on the two longitudinal sides of the wiper blade are each connectable to independent outer lines.

18. The wiper blade according to claim 17, wherein the port is designed as a multiple port with at least two connecting pieces.

19. The wiper blade according to claim 8, wherein the wiper blade body presenting the at least one spray duct surrounds a wiping rubber in the manner of a cap or a slide on an upper side facing away from a wiping lip.

20. The wiper blade according to claim 19, wherein the wiping rubber has at least one spring rail with which the wiping rubber is held on the wiper blade body in the manner of the cap or the slide on an upper side facing away from the wiping lip.
